(19) United States
(12) Patent Application Publication
(10) Pub. No.: US 2010/0075215 A1
(43) Pub. Date: Mar. 25, 2010

(54) THIN BATTERY AND A METHOD OF MANUFACTURING A THIN BATTERY

(75) Inventor: Xia Chang Zhang, Espoo (FI)

Correspondence Address: BROOKS KUSHMAN P.C., 1000 TOWN CENTER, TWENTY-SECOND FLOOR, SOUTHFIELD, MI, 48075, US

(73) Assignee: ENFUCELL OY, Vantaa (FI)

(21) Appl. No.: 12/525,710

(22) PCT Filed: Jan. 21, 2008
(86) PCT No.: PCT/FI2008/000011

§ 371 Date: Nov. 11, 2009

(30) Foreign Application Priority Data
Feb. 6, 2007 (FI) 20070107
Aug. 3, 2007 (FI) 20070584

(51) Int. Cl. H01M 2/16; H01M 4/82

(52) U.S. Cl. 429/144; 29/623.5

(57) ABSTRACT

The thin battery of the invention comprises an anode material, a cathode material, two or more separator paper layers there between, and electrolyte. One of the outer separator paper layers has an anode material applied thereon, another separator paper layer being an outer layer on the opposite side having a cathode material applied thereon. The method of the invention for manufacturing such a thin battery is mainly characterized by the steps of wetting a separator paper with an electrolyte solution, applying an anode material on a first separator paper and applying a cathode material on a second separator paper. The separator papers are then combined by pressing them together so that the anode and cathode materials are outmost, respectively in order to form a layered structure. The combined layers are then cut in desired sizes.

### TECHNICAL FIELD

The invention is concerned with a thin battery comprising an anode material and a cathode material, two or more separator paper layers there between, and electrolyte, as well as a method for manufacturing such a battery.

### BACKGROUND

The basic components of a battery are the electrodes with terminals to connect to an external circuit, a separator to keep the electrodes apart and prevent them from shorting, the electrolyte which carries the charged ions resulting from the chemical reactions taking place at the electrodes and a cover to contain the active chemicals and hold the electrodes in place.

“Wet” cells refer to galvanic cells where the electrolyte is liquid in form and is allowed to flow freely within the cell casing. “Dry” cells are cells that use a solid or powdery electrolyte. These kinds of electrolytes use the ambient moisture in the air to complete the chemical process. Cells with liquid electrolyte can be classified as “dry” if the electrolyte is immobilized by some mechanism, such as by gelling it or by holding it in place with an absorbent substance such as paper.

The most common type of battery used today is the “dry cell” battery. There are many different types of batteries ranging from the relatively. large “flashlight” batteries to the miniaturized versions used for wristwatches or calculators.

A carbon/zinc dry cell battery uses a zinc anode, a manganese dioxide cathode, and an electrolyte of ammonium chloride and/or zinc chloride dissolved in water.

Batteries are often classified by the type of electrolyte used in their construction. There are three common classifications; acid, mildly acid, and alkaline.

Batteries make use of chemical reactions that involve oxidation and reduction reactions (redox reactions).

In an acidic dry cell, the reduction reaction can e.g. occur in moist pastes between zinc chloride (ZnCl₂) electrolyte and manganese dioxide (MnO₂) cathode. The anode reaction occurs between zinc chloride (ZnCl₂) electrolyte and atomic zinc:

The cathode reduction being:

8MnO₂+8H⁺+8e⁻−>8MnOOH

and the anode oxidation reaction being:

4Zn+ZnCl₂+9H₂O−>ZnCl₂.4ZnO.5 H₂O+8H⁺+8e⁻

and the overall redox reaction being:

8MnO₂+4Zn+ZnCl₂+9H₂O−>8MnOOH+ZnCl₂. 4ZnO.5 H₂O

This dry cell “couple” produces about 1.5 volts.

All batteries utilize similar procedures to create electricity; however, variations in materials and construction have produced different types of batteries.

Batteries with one or more paper layer separators have been previously presented in e.g. U.S. Pat. No. 6,379,836. An electric double layer capacitor having a paper sheet between the electrodes is presented in U.S. Pat. Nos. 5,157,586 and 6,104,600.

One battery type consists of a layered structure, i.e. those called thin film batteries.

Thin film batteries, which term in this text is to be understood as “layered-structured batteries” regardless of size, can be deposited directly onto chips or chip packages (or vice versa, the chips can be deposited onto the batteries) in any shape or size, and flexible batteries can be made by printing on to paper, plastics, or other kind of thin foil.

Because of their relatively small thickness, the energy storage and current carrying capacity of thin film batteries is low, these properties being, however, dependent on their area as well and can be made sufficient for desired applications. They have unique properties which distinguish them from conventional batteries, and in fact the capacity is still enough for a lot of applications.

Thin film batteries have e.g. a wide range of uses as power sources for consumer products and for micro-sized applications. Flexible film batteries are also suitable for powering smart cards and Radio Frequency IDentification (RFID) tags.

Intensive work is currently done for making constantly improved batteries by solving some acknowledged problems in connection with the manufacturing of the batteries and in order to decrease occurring short-circuiting problems.

Short circuiting mainly occurs upon direct contact between the electrodes over the edges or as a result of the corrosion of zinc leading to formation of electrically conductive dendrite, which contains zinc oxide. Earlier solutions, such as those presented in the aforementioned US patents, to solve the short-circuiting problem have focused on the separator material e.g. in order to make it dense or thick enough and thus impermeable for the dendrite.

Battery separators in conventional batteries, such as in alkaline batteries, are traditionally prepared by using a paper making machine, such as in the above U.S. Pat. No. 6,379,836. In these methods, the separator layers, including the layer impregnated with electrolyte, can be integrally laminated, at the paper making stage, or they can be made separately and then be laminated directly thereafter. Thus, integration of the different separator paper layers is usually performed by laminating the liquid impregnate layer on one or both sides in the paper making stage, by using a paper making machine able to combine the layers.

In addition to the above mentioned problem of short-circuiting over the edges, another problem in traditional manufacturing methods to overcome is that the paper sheets become quite wet when they are impregnated with the electrolyte, which makes the application of the electrode materials difficult.

### SUMMARY OF THE INVENTION

The thin battery of the invention, which overcomes the above mentioned problems, comprises an anode material, a cathode material and two or more separator paper layers there between. The battery also comprises electrolyte. One of the outer separator paper layers has an anode material applied thereon as a paste, another separator paper layer being an outer layer on the opposite side having a cathode material applied thereon as a paste.

The method of manufacturing such a thin battery by applying an anode material and a cathode material on separator paper is mainly characterized by the steps of wetting a separator paper with an electrolyte solution, applying an anode material on a first separator paper, applying a cathode material on a second separator paper, combining the separator papers after the foregoing steps by pressing them together so that that the anode and cathode materials are outmost, respectively. The combined separator papers are then cut in desired sizes.

The different embodiments of the invention have the characteristics of the subclaims.

Thus, there can be two separator paper layers or three or more separator paper layers. When there are three or more of them, it is preferably the intermediate separator paper layer(s) that is wetted with the electrolyte solution but also the outmost separator layers will always contain electrolyte, since they absorb electrolyte from the wetted layer. The electrolyte solution contains additives and it is also mixed with the anode active material and cathode active materials to form sc. anode and cathode pastes.

The electrodes are formed of the anode and the cathode. The anode material consists of a paste containing an anode active material and electrolyte solution with additives and the cathode material consists of a paste containing a cathode active material and electrolyte solution with additives.

The application method used to apply the cathode and anode pastes is either coating or printing.

The term application shall in this text clearly be understood apart from the process of lamination mentioned in the prior art section meaning building up successive layers of a solid substance, such as wood or textiles, and bonding them with resin to form a finished product.

Preferably, the anode active material is zinc (Zn) and the cathode active material is manganese dioxide (MnO₂).

The electrolyte solution preferably contains ZnCl₂ as a main ingredient in an amount of 3-10 M, preferably 8 M as well as additive(s) as other ingredient(s), such as for example binder(s).

The additive(s) in the electrolyte comprises binder(s) in order to bind the electrode material particles to the paste. The binder is e.g. polyvinylalcohol (PVA) in an amount of 2-10%, preferably 3-4%, of the electrolyte.

Conductive material is added to the anode and cathode pastes. The conductive material can be carbon powder, such as graphite powder, soot, or carbon black or combinations thereof in an amount of 1-5%, preferably ca 2%, in the anode paste and in an amount of 5-20%, preferably ca 10%, in the cathode paste (because MnO₂ is not conductive enough).

The electrodes are connected to a collector material and the whole product is covered in an envelope. The envelope cover can be of e.g. polypropylene, polyethylene, polyester or other known cover materials. The collector material is formed to have terminals outside the layers to be connected to an external circuit. The collector material can be conductive carbon ink, carbon film or other material, which is chemically inert but conductive enough for the purpose.

The anode and cathode materials can be applied on the separator papers with different methods such as by coating or printing.

With the term application, it is in this text meant that a material paste is applied on a substrate either with coating or printing. Coating and printing processes generally involve the application of a thin film of functional material to a substrate, such as roll of paper, fabric, film or other textile.

With the term paste, it is in this text just meant, a viscous water-based dispersion of materials.

Preferably, the invention uses coating for the application of the anode and cathode materials, such as blade coating. When blade coating is used, then a cutting step is performed before or after the combination of the layers, performed by die cutting. Excessive anode and cathode material or excessive outer layer material is then removed by scrapping form the outer sides so that the separator paper layers would have a bigger area than that of the electrodes. When other coating methods are used, the coated layer is just cut in desired sizes.

When the application is performed by printing it is performed by means of a roll outside which there is a mask. The mask is designed to print areas of certain sizes on those paper webs that will constitute the outer separator layers.

After the application of the collector material, the layers are cut by longitudinal and transversal cutting steps (slit cutting and across cutting) to form products, wherein the separator paper layers have a bigger area than the areas of anode and cathode material or wherein the intermediate separator paper layer(s) have a bigger area than the outer coated or printed separator paper layers.

The method of the invention enables the manufacturing of a product, wherein the surface area of at least the intermediate separator paper layer is bigger than those of the electrodes thereby hindering short-circuiting, i.e. a direct contact between the cathode and the anode.

The invention is environmentally friendly in that it uses a thin paper sheet as a conduit. It pastes one paper layer with anode paste and another paper layer with cathode paste and impregnates a third intermediate paper layer with zinc chloride electrolyte. The electrolyte can be impregnated in the outer layer(s) also. In a certain embodiment there are, however, only two separator paper layers. In that case, at least one of these layers is impregnated with electrolyte, usually the anode.

The main benefit of the invention is that the use of multiple papers in the separator layer makes the production of the battery easier than the methods used in prior art. The earlier mentioned wet strength problems in the prior art methods with wet cathode and anode layers can be avoided by means of the invention.

In addition to the production benefit, the multiple paper structure makes the risk of short circuiting smaller. This is based on both experience and on the theory that zinc needles that are formed in the anode do not penetrate several layers of paper as easily as they penetrate one layer. The main benefit, however, in preventing short-circuiting lies in that, as the intermediate separator layer(s) are bigger in area, the short-circuiting over the edges is prevented.

The product of the invention have several potential use applications, such as RFID tags, as batteries to give power for microsensors, in music and greeting cards and generally in low power applications, such as in Light Emitting Diodes (LEDs).

RFID (radio frequency identification) tags are the tiny chips that are replacing bar codes. They wirelessly transmit information about themselves, making it easier to track what is in stock in a store. Battery-powered RFID tags can transmit farther than non-battery-powered versions and push RFID signals through liquid and metal cans—two common signal stoppers in supermarkets.

In the following, the invention will be described by means of some examples to which the invention is not restricted. As was already mentioned before, the number of separator layers can vary, as well as the order of some processing steps, i.e the cutting can be performed differently in different embodiments.

### FIGURES

FIG. 1 is a schematic cross-section of one product of the invention, wherein the different layers applied with coating can be seen.

FIG. 2 is a schematic cross-section of another product of the invention, wherein the different layers applied with printing (or coating) can be seen.

FIG. 3 is a schematic cross-section of still another product of the invention, wherein the different layers applied with printing (or coating) can be seen.

FIG. 4 is a schematic description of the main principles of one embodiment of the method of the invention

FIG. 5 is a schematic description of the main principles of another embodiment of the method of the invention

FIG. 6 is a schematic description of the main principles of a third embodiment of the method of the invention

### DETAILED DESCRIPTION

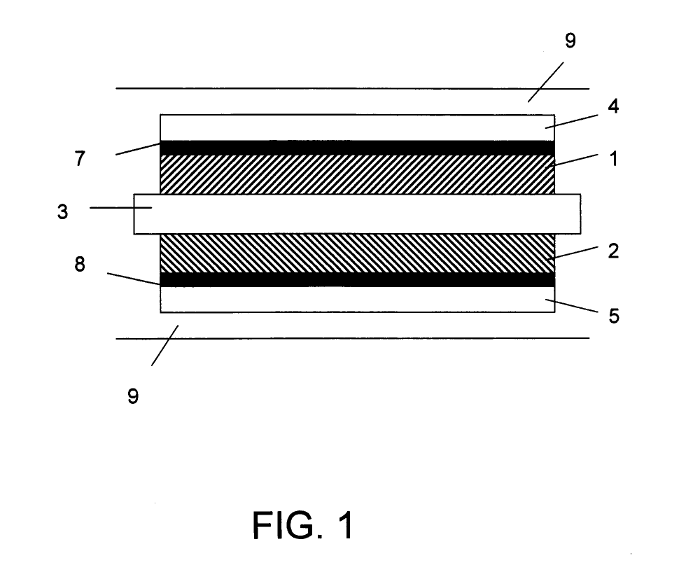

FIG. 1 shows the different layers of the product in one embodiment of the invention in cross-section. The thin battery of FIG. 1 comprises an anode material layer 7 coated on a paper strip 1 and a cathode material layer 8 coated on another paper strip 2 and a third paper strip 3 there between. The paper strips 1, 2 and 3 form the separator paper layers in the product. The anode and cathode material layers 7, 8 forming the electrodes are covered by collector layers 4, 5 on both sides. The electrodes 7, 8 are in contact to the collectors via the terminals of the collectors 4, 5. The electrical current is fed from the electrodes 7,8 via the collectors 4, 5 to an external circuit. The whole product is further covered in an envelope structure 9.

The electrodes 7, 8 consisting of the anode and cathode materials 7, 8 are connected to the terminals of the collectors 4, 5 (can not be seen in this cross-section) in order to connect the electrodes 7, 8 to an external circuit. The anode active material 7 is e.g. zinc (Zn) and the cathode active material 8 is e.g. manganese dioxide (MnO₂).

All three separator paper layers 1, 2, 3 act as separators keeping the anode and cathode material layers 7, 8 apart and preventing the electrodes 7, 8 from short-circuiting. In FIG. 1, the surface area of the intermediate separator paper layer 3 is bigger than that of separator paper layers 1, 2 having the anode and cathode active materials 7, 8 coated thereon. The difference between separator area and electrode area is usually in the order of 0.5-1 mm, the whole area of the layers being in the range of ca 10-25 cm², typically about 15 cm². The invention is, naturally not limited to any particular size of the battery, since there are e.g. applications with an area sizes of only 1 cm² and up to even ca 1 m². When a separator paper layer, like e.g. the intermediate separator paper layer 3 in FIG. 1, is bigger in area than the electrode areas, the electrodes are prevented from coming into contact with each other over the edges.

At least the intermediate separator paper layer 3 is wetted with the electrolyte, which carries the charged ions between the electrodes 7, 8, when the electrodes 7, 8 are connected to an external circuit and the battery is in use. In practice, also the other layers contains electrolyte.

The layers (1, 2, 3, 4, 5, 7, 8) of the battery are inside a cover 9 to hold the electrodes 7, 8 in place.

The battery further comprises binders, a conductive material (such as carbon powder) and other additives. Electrolyte solution with additives is also mixed with the anode and cathode active materials 7, 8 to form an anode paste and a cathode paste, with which the outer separator paper layers 1,2 are coated or printed.

The layers (1, 2, 3, 4, 5, 7, 8) are of different thicknesses and/or densities and have different combinations of known additives depending on which final characteristics are of most concern.

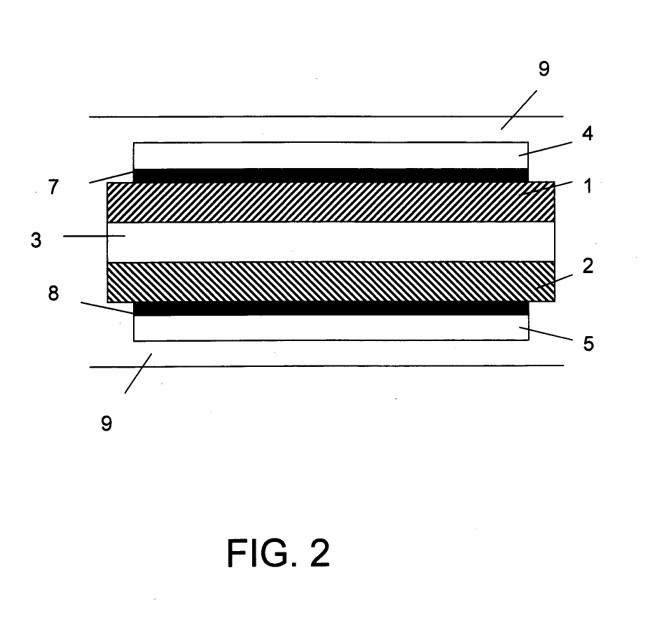

FIG. 2 is a schematic cross-section of another product of the invention, wherein the different layers can be seen. It is otherwise similar to that of FIG. 1, but here all the separator paper layers 1, 2, 3 are bigger in area than that of the anode and cathode active materials 7, 8. A product of FIG. 2 is a result of using the printing method for the application of the cathode and anode materials 7, 8 but can also be produced by means of coating if only cathode and anode material 7, 8 is scrapped away but not any separator paper.

Of course also such products could be manufactured, wherein e.g. the separator paper 1 layer under the anode material would have a bigger area than the anode layer 7 but the separator paper layer 2 under the cathode material 8 would have the same area as the cathode material 8 or vice versa.

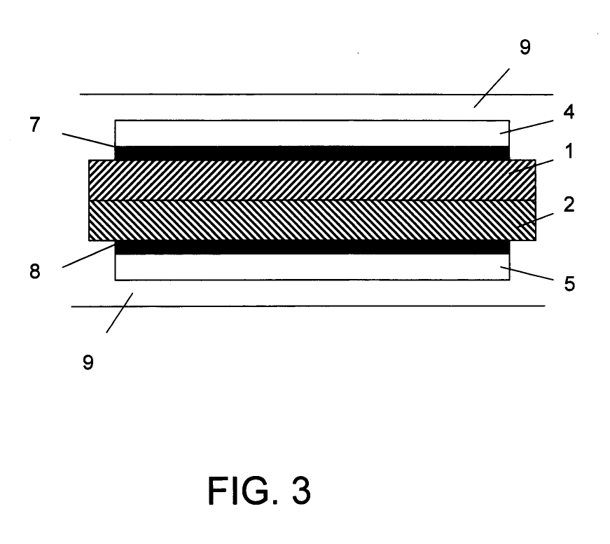

FIG. 3 is a schematic cross-section of still another product of the invention, wherein the different layers applied with printing (or coating) can be seen. It is otherwise like that in FIG. 2 but layer 3 is missing.

It has to be noted that none of FIGS. 1-3 is in scale.

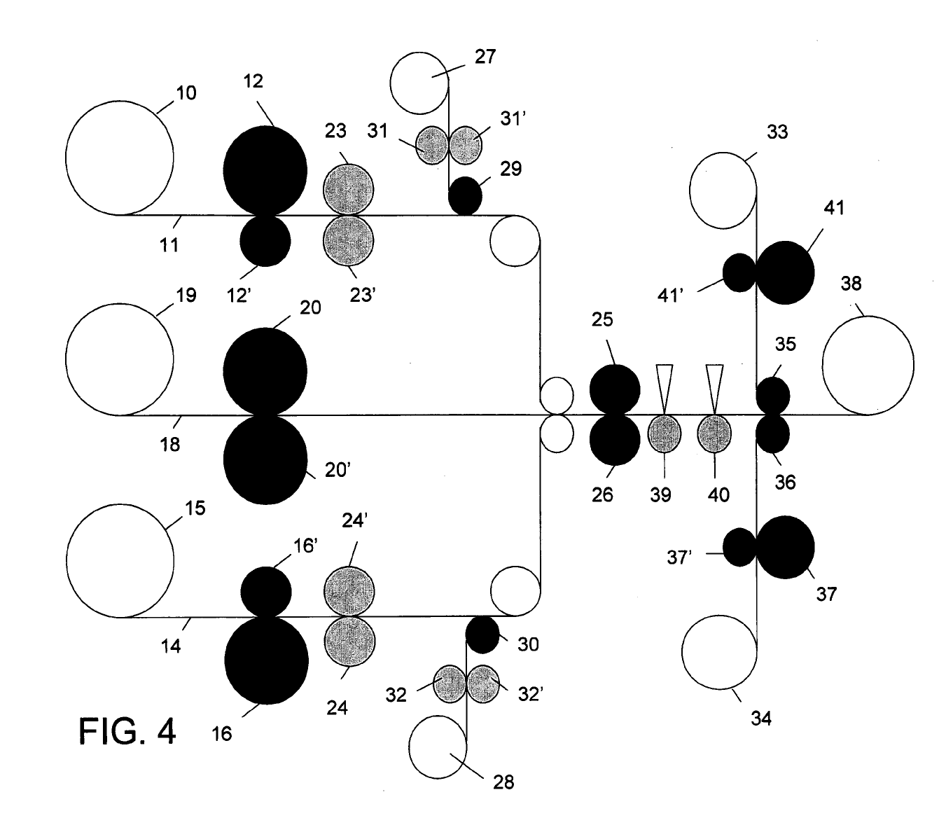

FIG. 4 describes the main principles of such an embodiment of the method of the invention, wherein the manufacturing of the thin battery of the invention takes place by coating an anode paste on a first separator paper, coating a cathode paste on a second separator paper, and wetting a third separator paper with an electrolyte solution containing desired additives.

A paper web 11 to constitute the first separator paper layer is fed from an unwinding paper roll 10. An anode paste containing the anode active material (such as zinc powder), electrolyte and desired additives, is coated in FIG. 4 by means of some coating method known in itself on a web of paper supported by a backing roll 12. The web 11 goes through a nip formed of the backing roll 12 and another roll 12′. Coating methods that could be used are e.g. the blade coating method, metering bar coating, air brush coating, size press coating, spray coating or curtain coating.

Another paper web 14 to constitute the second separator paper layer is fed from an other unwinding paper roll 15. A cathode paste containing the cathode active material (such as manganese dioxide), electrolyte and desired additives, is coated in FIG. 4 by means of some coating method as well. The cathode paste is coated by facing the web 14 against the backing roll 16, the web going through the nip 16, 16′.

The anode coating is usually made thinner than the cathode coating.

A third paper web 18 to constitute the third separator paper layer is also fed from a paper roll 19. It is in FIG. 4 wetted with a solution containing the electrolyte (such as zinc chloride) and desired additives, by means of a roll 20 by feeding the web 18 through the nip 20, 20′. Alternatively, the electrolyte solution could be added by dropping the paper web 18 in a container containing the electrolyte solution. Layer thickness needed for electrolytes depends e.g. on the capacity per square centimeter needed from the battery.

Before combining the three webs 11, 14 and 18 (or possible after the combining step), the webs 11 and 14 to form the outmost layers are exposed for die cutting performed through the nips 23, 23′ and 24, 24′, respectively to form pieces of desired areas of coating. FIGS. 1 and 2 present the different layers of the battery of the invention in cross-section. Paper web 11 of FIG. 4 will form separator paper layer 1, paper web 18 of FIG. 4 will form separator paper layer 3, and paper web 14 of FIG. 4 will form separator paper layer 2.

Thereafter anode collector material is added on the anode side of the product from roll 27 and cathode collector material on the cathode side of the product from roll 28 by means of rolls 29, 30. The collector material is cut in suitable pieces by means of rolls 31, 31′ and 32, 32′, respectively and again, the waste is collected in waste rolls (not shown). The collector material has the desired form to have terminals outside the separators.

For the combining step, the three webs are fed through some rolls and pressed together. The three webs 11, 14, 18 are brought together, with web 18 in the middle, and combined by pressing by means of rolls 25, 26.

For preparing such a battery product of FIG. 1, in which the intermediate separator paper layer 3 is bigger in area than the other separator paper layers 1, 2, (hereby preventing direct contact between the electrodes), excessive areas of coating and outer paper material 11, 14 are scrapped away. The scrapped material is collected in waste rollers (not shown).

For preparing such a battery product of FIG. 2, in which all separator paper layers 1, 2, 3 are bigger than the anode and cathode paste layers 7, 8 (hereby preventing direct contact between the electrodes), excessive areas of coating and outer paper material 11,14 are scrapped away. The scrapped material is collected in waste rollers (not shown).

The product is then exposed for slit (longitudinal) cutting with cutting machine 39 and for across (transversal) with cutting machine 40 to form products of desired size.

Last, a cover material is added on both sides with a surface film from rolls 33, 34 by means of heat sealing with rolls 35, 36 to from an envelope around the product. The cover can be a plastic film of e.g. polypropylene or polyethylene and it can even be a metallized film. FIG. 4 also shows a perforating roller 37 against roll 37′ in order to perforate the film on the cathode side and a perforating roller 41 against roll 41′ to perforate the film on the anode side. The ready product is collected in roll 38.

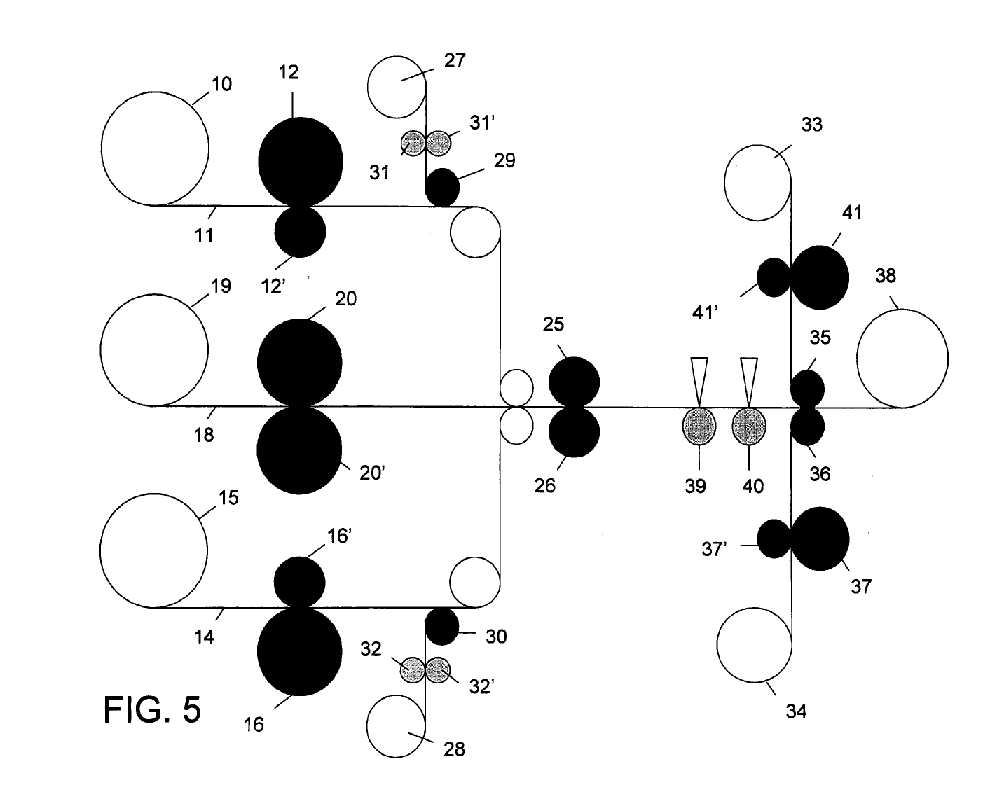

FIG. 5 describes the main principles of another embodiment of the method of the invention, wherein the manufacturing of the thin battery of the invention takes place by printing an anode paste on a first separator paper, printing a cathode paste on a second separator paper, and wetting a third separator paper with a solution containing the electrolyte and desired additives.

As in FIG. 4, a paper web 11 to constitute the first separator paper layer is fed from an unwinding paper roll 10. An anode paste containing the anode active material (such as zinc powder), electrolyte and desired additives, is in this embodiment printed on the paper web by means of a roll 12 with a mask on the outside of the roll so that the paste only passes to the web through those places in the mask wherein there are holes.

Correspondingly, a paper web 14 to constitute the second separator paper layer is fed from an unwinding paper roll 15. A cathode paste containing the cathode active material (such as MnO₂), electrolyte and desired additives, is in this embodiment printed on the paper web by means of a roll 16 with a mask on the outside of the roll so that the paste only passes to the web through those places in the mask wherein there are holes, the so called screen printing method.

The mask on both the rolls 12 and 16 can be designed in different ways to print areas of paste of desired shapes on the web. In the invention, the anode and cathode pastes can be printed in such a way that when all three webs 11, 14 and 18 are later combined and cut, the printed areas of cathode and anode paste is smaller than that of the area of layers separator paper layers 1, 2, 3. Thus, with the method of FIG. 5, a product like that presented in FIG. 2 can be made.

Different printing methods to be used in the invention include screen printing, rotogravure printing, jet printing and maybe flex-printing.

As in FIG. 4, a third paper web 18 to constitute the third separator paper layer is also fed from a paper roll 19. It is as in FIG. 4 wetted with a solution containing the electrolyte (such as zinc dichloride) and desired additives, such as polyvinylacohol, by means of a roll 20. Alternatively, the electrolyte solution could be added by dropping the paper web 18 in a container containing the electrolyte solution.

Thereafter anode collector material is added on the anode side of the product from roll 27 and cathode collector material on the cathode side of the product from roll 28 by means of rolls 29, 30. The collector material is cut in suitable pieces by means of rolls 31, 31′ and 32, 32′, respectively and again, the waste is collected in waste rolls (not shown). The collector material has the desired form to have terminals outside the separators.

There after as in FIG. 4 all the three webs 11, 14, 18 are brought together, with web 18 in the middle, and combined by pressing by means of rolls 25, 26 and the rest of the steps are as in FIG. 4.

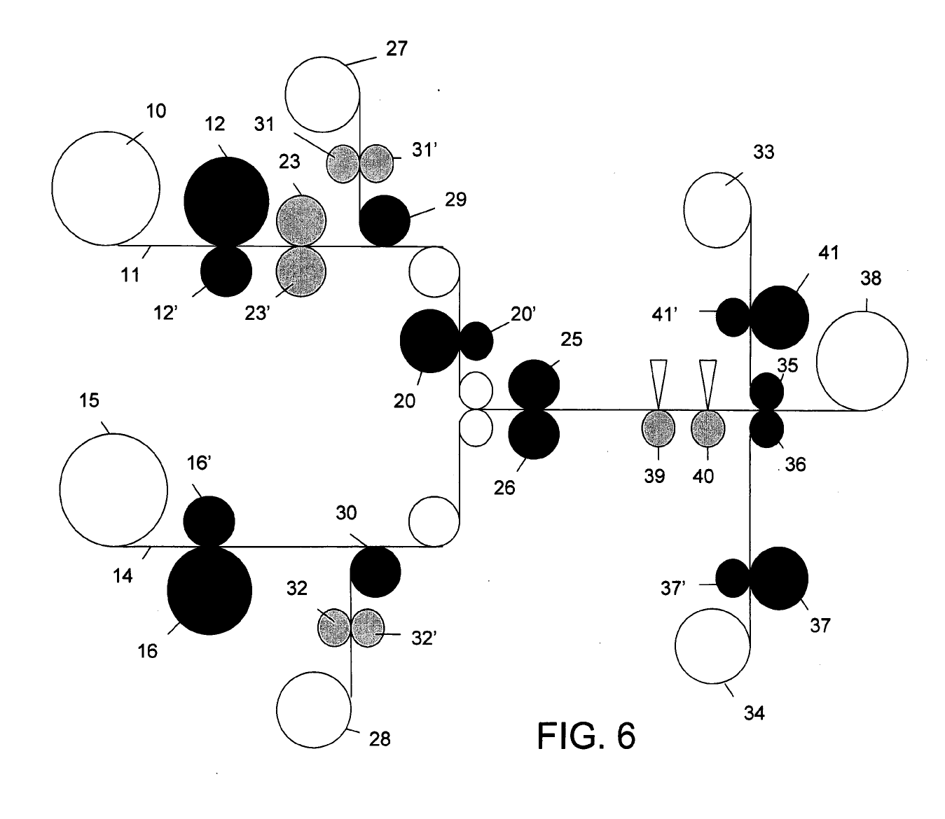

FIG. 6 describes the main principles of still one embodiment of the method of the invention.

Here, the manufacturing of the thin battery of the invention takes place by coating or printing an anode paste on a first separator paper, coating or printing a cathode paste on a second separator paper, one of which papers, usually the one to be coated with the anode material has been wetted with a solution containing the electrolyte and desired additives.

If, as is the case in FIG. 6, the anode and cathode pastes are applied by means of coating like in FIG. 4, die cutting is performed by means of rolls 23, 23′ to form pieces of desired areas of cathode and anode layers (having reference numbers 7,8 in FIG. 3).

Thereafter anode collector material is added on the anode side of the product from roll 27 and cathode collector material on the cathode side of the product from roll 28 by means of rolls 29, 30. The collector material is cut in suitable pieces by means of rolls 31, 31′ and 32, 32′, respectively and again, the waste is collected in waste rolls (not shown). The collector material has the desired form to have terminals outside the separators.

In FIG. 6, web 11 is thereafter wetted with a solution containing the electrolyte (such as zinc chloride) and desired additives, by means of a roll 20 by feeding the web 11 through the nip 20, 20′. (Alternatively, the electrolyte could be applied to web 14, but it is considered to be preferable to apply the electrolyte on the anode side.

There after the two webs 11, 14, are brought together and combined by pressing by means of rolls 25, 26.

For preparing such a battery product of FIG. 3, in which the separator paper layer 1 and 2 is bigger in area than the electrodes 7, 8 thereby preventing direct contact between the electrodes, excessive areas of coating are scrapped away and the scrapped material is collected in waste rollers (not shown).

Such a product can also be done, wherein only one of the separator paper layers is bigger in area than the electrodes 7, 8. Then only the desired part of anode or cathode material is scrapped away.

If the printing method is used, desired areas of electrode material can be printed so that layers 7, 8 would be smaller in area than the one or both of the separator paper layers 1, 2.

Thereafter the steps are like that in FIGS. 4 and 5.

It can now easily be seen that a lot of variations are possible for the method within the scope of the inventive idea presented in the claims and that the figures are presented as examples only.

The cathode and anode pastes can for example be applied with different methods to each other (e.g. the anode with printing and the cathode with coating), printing could e.g. be used in an embodiment with only two separator paper layers, only one or then more or all layers can be wetted with electrolyte, and so on.

1. A thin battery having a layered structure, comprising an anode material layer, a cathode material layer, two or more separator paper layers there between, and electrolyte solution, wherein one of the outer separator paper layers has the anode material coated or printed thereon as a paste, and another separator paper layer being an other outer layer on the opposite side having the cathode material coated or printed thereon as a paste.

2. A thin battery of claim 1, wherein there are two separator paper layers one of the separator paper layers having its outer surface coated or printed with an anode material and the other separator layer having its outer surface coated or printed with a cathode material.

3. A thin battery of claim 1, wherein there are three or more separator paper layers one of the outer separator layers having its surface coated or printed with an anode material and the other outer separator layer on the opposite side having its surface coated or printed with a cathode material.

4. A thin battery of claim 1, wherein the area of at least one of the separator layers is bigger than that of the anode and/or cathode materials.

5. A thin battery of claim 3, wherein the area of at least one of the intermediate separator layers is bigger than the outer separator layers, the outer layers having the anode and cathode materials coated or printed thereon.

6. A thin battery of claim 1, wherein the electrolyte solution contains electrolyte and additives.

7. A thin battery of claim 1, wherein the electrolyte is ZnCl₂.

8. A thin battery of claim 7, wherein the amount of ZnCl₂ is 3M-10M.

9. A thin battery of claim 8, wherein the amount of ZnCl₂ is 8M.

10. A thin battery of claim 1, wherein the anode material consists of a paste containing an anode active material and an electrolyte solution with additives and the cathode material consists of a paste containing a cathode active material and an electrolyte solution with additives.

11. A thin battery of claim 10, wherein the anode active material is zinc (Zn) and the cathode active material is manganese dioxide (MnO₂).

12. A thin battery of claim 9, wherein the additives in the electrolyte solution comprise binder.

13. A thin battery of claim 12, wherein the binder is Poly vinyl alcohol (PVA) in an amount of 2-10% of weight.

14. A thin battery of claim 12, wherein the binder is Poly vinyl alcohol (PVA) in an amount of 3-4% of weight of the electrolyte solution.

15. A thin battery of claim 10, wherein the pastes further comprise conductive material, such as carbon powder, for example graphite powder, soot, or carbon black or combinations thereof in an amount of 1-5% of weight in the anode paste and in an amount of 5-20% of weight, in the cathode paste.

16. A thin battery of claim 10, wherein the conductive material is carbon powder, graphite powder, soot, carbon black or combinations thereof.

17. A thin battery of claim 15, wherein the amount of the conductive material is 2% in the anode paste and 10% in the cathode paste

18. A thin battery of claim 1, wherein the battery further comprises collectors for the cathode and anode material layers.

19. A thin battery of claim 1, wherein the battery further comprises a cover material outside the collector material layer, the cover material being polypropylene, polyethylene, or polyester.

20. Method of manufacturing a thin battery having a layered structure comprising an anode material layer, a cathode material layer, two or more separator paper layers there between, and electrolyte, the method comprising the steps of:
a) coating or printing anode and cathode materials on the separator paper,
b) wetting the separator paper with an electrolyte,
c) coating or printing an anode material on the first separator paper,
d) coating or printing a cathode material on the second separator paper,
e) combining the separator papers after the foregoing steps by pressing them together in order to form a layered structure, so that that anode and the cathode material layers are outmost, respectively, and
f) cutting the combined layers of the foregoing step.

21. Method of claim 20, wherein a battery comprising two separator paper layers (1, 2) is produced, whereby step a) is performed on the same separator paper as step b) or c).

22. Method of claim 20, wherein a battery comprising three or more separator paper layers is produced, whereby step b) is performed on one or more of the separator layers.

23. Method of claim 20, wherein at least one of steps c)-d) is performed by coating.

24. Method of claim 20, wherein the at least one of steps c)-d) is performed by coating and the at least one of the outer layers of separator paper coated with anode or cathode material, is cut in pieces of desired areas after step c) or after step d), in order to have an area smaller than at least one of the other layers inside them.

25. Method of claim 23, wherein before or after the combination step, the coated layer is die cut and excessive anode and/or cathode material is removed by scrapping from the outer sides so that the separator papers would have a bigger area than that of the anode and cathode materials.

26. Method of claim 23, wherein before or after the combination step, the coated layer is die cut and excessive outer layer anode and/or cathode and separator paper material from the outer layers is removed by scrapping so that at least one of the intermediate separator paper layers would have a bigger area than that of the outer separator layers.

27. Method of claim 23, wherein before or after the combination step, the coated layer is die cut and excessive outer layer material from the outer layers is removed by scrapping so that at one of the intermediate separator layers would have a bigger area than the cathode and anode materials.

28. Method of claim 20, wherein at least one of steps c)-d) is performed by printing with a roll outside which there is a net with a designed pattern of holes.

29. Method of claim 28, wherein the net is designed to print areas of certain sizes on the separator papers, so that the areas of anode and cathode material would be smaller than the separator paper layers.

30. Method of claim 20, wherein a collector material is applied outside the outer layers before step e).

31. Method of claim 20, wherein the cutting in step f) is performed by longitudinal and transversal cutting steps to form products of desired sizes.

32. Method of claim 20, wherein a cover material is applied outside the collector material after step e).
